(19) United States
(12) Patent Application Publication
(10) Pub. No.: US 2011/0076470 A1
(43) Pub. Date: Mar. 31, 2011

(54) METHOD OF MAKING AESTHETIC PANELS WITH ENHANCED ACOUSTIC PERFORMANCE

(75) Inventor: Mitul D. Zaveri, Norristown, PA (US)

(73) Assignee: CertainTeed Corporation, Valley Forge, PA (US)

(21) Appl. No.: 12/568,809

(22) Filed: Sep. 29, 2009

(51) Int. Cl. B32B 3/10; B32B 38/14; B32B 38/04; B32B 38/10

(52) U.S. Cl. 428/196; 156/277; 156/264; 156/250

(57) ABSTRACT

A method of manufacturing an acoustic ceiling panel having an aesthetic covering includes the steps of: providing a non-woven fabric having an outer major printable surface and an inner major surface; printing an image onto the printable surface of the non-woven fabric using a high-speed printing process, the image being provided from at least one image carrier; providing a base ceiling substrate having selected acoustical properties, the base ceiling substrate having an outer major surface; and adhering the inner major surface of the non-woven fabric to the outer major surface of the base ceiling substrate to form a laminated panel, wherein the non-woven fabric is acoustically transparent relative to the base ceiling substrate.

### FIELD OF THE INVENTION

The present invention relates to aesthetic paneling and more particularly to acoustic paneling.

### BACKGROUND OF THE INVENTION

Decorative panels formed of wood and/or veneer are sometimes used as ceiling panels. The products presently on the market are heavy and difficult to install. Perhaps more importantly, these decorative panels do not provide any significant acoustical (sound absorption) value. These products have Noise Reduction Coefficient (NRC) values of under 0.50. One product currently on the market places a fiberglass board behind a perforated wood panel. The perforations allow sound to travel back to the acoustic fiberglass panel. Even this combined product has relatively poor acoustic performance, achieving a reported NRC of only 0.40-0.50. An improved acoustic panel is desired.

### SUMMARY OF THE INVENTION

A method of manufacturing an acoustic ceiling panel having an aesthetic covering includes the steps of: providing a non-woven fabric having an outer major printable surface and an inner major surface; printing an image onto the printable surface of the non-woven fabric using a high-speed printing process, the image being provided from at least one image carrier; providing a base ceiling substrate having selected acoustical properties, the base ceiling substrate having an outer major surface; and adhering the inner major surface of the non-woven fabric to the outer major surface of the base ceiling substrate to form a laminated panel, wherein the non-woven fabric is acoustically transparent relative to the base ceiling substrate.

The above and other features of the present invention will be better understood from the following detailed description of the preferred embodiments of the invention that is provided in connection with the accompanying drawings.

### BRIEF DESCRIPTION OF THE DRAWINGS

The accompanying drawings illustrate preferred embodiments of the invention, as well as other information pertinent to the disclosure, in which:

FIG. 1 is an exploded view of a panel of the present invention;

FIGS. 2-2F are side views of embodiments of a ceiling panel of the present invention;

FIG. 3 is a perspective view of a ceiling made up of panels of the present invention;

FIG. 4 is a stylized image of a rotogravure printing press for use in printing an image on the nonwoven fabric of the panel of the present invention;

FIG. 5 is a flow diagram illustrating a method of making a panel of the present invention; and

FIG. 6 is a stylized image of a screen printing press for use in printing an image on the nonwoven fabric of the panel of the present invention.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The present invention relates to a panel, such as a ceiling panel, that can be customized with a design or image to yield an aesthetically pleasing appearance without sacrificing acoustical. More specifically, a high-speed printing process, such as a rotogravure or screen printing method, is used to print an image on a semi-porous non-woven fabric that is then laminated to an underlying acoustical board. By semi-porous, it is meant that the fabric has sufficient fiber content to ensure good printability, but that that it is not so porous that it appears to have perforations (i.e., the pores in the fabric are not visible through the naked eye. In exemplary embodiments, the image that is printed on the non-woven fabric corresponds to a wood finish, including realistic coloring and grain.

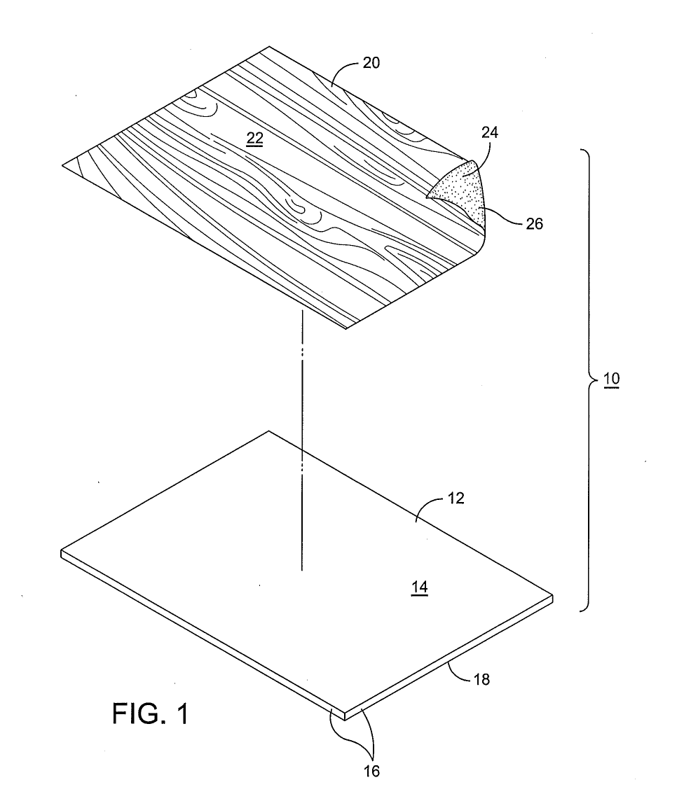

With reference to FIG. 1, the two primary components of the panel 10 are a base ceiling substrate 12 having selected acoustical properties and a flexible non-woven fabric 20. The base ceiling substrate 12 has a top major surface 14, a bottom major surface 18 and side surfaces 16. The base ceiling substrate 12 can be formed from a mineral board, fiberglass board, gypsum board, rigid foam board, hard board, or medium density fiberboard depending on the desired acoustical properties. All of these boards are known in the art for use as ceiling or wall panels. It is within the scope of the present invention to use other types of boards for the base ceiling substrate 12. The only essential requirements for base ceiling substrate are that it be a rigid panel with desirable physical characteristics, such as sound insulating properties, and that it be capable of being suspended in a ceiling grid (or within a wall in embodiments). As those skilled in the art will appreciate, the base ceiling substrate 12 described herein can be constructed in any number of shapes or sizes as required by the intended use. The most common sizes are 2′×2′, 2′×4′ and 4′×4′ panels.

By varying the material of base ceiling substrate 12 behind the fabric layer 20, the acoustical properties of the panel can be changed considerably from a high sound absorptive panel (e.g., fiberglass) to a sound reflective panel (e.g., gypsum board) as desired. The base ceiling substrate 12 may have a variety of densities, ranging from 2.5 to 20.0 lbs/ft³, and thicknesses, ranging from 0.40-3.0″.

The fabric layer 20 includes top, image-receiving, printable surface 22 and a bottom surface 24. An adhesive layer 26 is shown on the bottom surface 24 of fabric 20 for adhering the fabric 20 to the top major surface 14 of the substrate 12. The preferred non-woven fabric 20, which may alternatively be referred to as a mat layer, is preferably formed from a non-woven blend of cellulosic and synthetic fibers. In one exemplary embodiment, the non-woven fabric 20 is a combination of fiberglass, cellulosic and synthetic fibers. In one exemplary embodiment, the blend is a combination of polyester, polypropylene, wood fiber, fiberglass and/or viscose rayon fibers. Depending on the application, the various constituent fibers can be varied. This construction yields a relatively lightweight sheet that is semi-porous and allows for limited absorption of printing ink. This limited ink absorption, in turn, yields a printable surface with desirable physical properties. In embodiments, the non-woven fabric layer 20 has a basis weight in the range of about 50-250 g/m² and a thickness of between about 0.010-0.200″. The porosity of the fabric 20 should be balanced between printability and sound transparency. That is, the fabric should not be so porous that print quality suffers or be so closed, such that sound transfer to the underlying substrate is adversely affected. One possible means by which porosity could be quantified is by performing air permeability tests. This combination of features yields a fabric layer 20 that is acoustically transparent, semi-porous, visually opaque (enough to acceptably mask the underlying substrate 12), printable and durable enough to be processed in high-speed printing processes and post-printing sizing operations. The fabric holds multiple layers of ink on its surface 22 without allowing the ink to penetrate to the base ceiling substrate layer and without “sealing off” the underlying substrate layer 12.

As shown in FIG. 1, one exemplary image printed on the image receiving surface 22 is an image that achieves a wood appearance. Several coats of ink can be applied and the chosen grain added to achieve this appearance. In exemplary embodiments, the non-woven fabric 20 before the fabric 20 is laminated to the base ceiling substrate 12.

The inner surface 24 of the non-woven fabric 20 is adapted to be laminated to the outer surface 14 of the base ceiling substrate 12 via adhesive layer 26. In embodiments, the adhesive layer 26 includes an ethyl vinyl acetate (EVA) adhesive. The adhesive layer can be applied directly to either the surface 24 of the fabric 20 (as shown) or to the surface 14 of the base ceiling substrate 12, or both. Pressure can be applied, such as using rollers (not shown), to facilitate a good bond between the surfaces. However, those skilled in the art will undoubtedly be familiar with the other suitable laminating techniques. The only requirement is that non-woven fabric 22 and base substrate 12 be adhesively joined in a manner that resists delamination and results in a smooth panel surface 22. The laminated layers together constitute laminated panel 10.

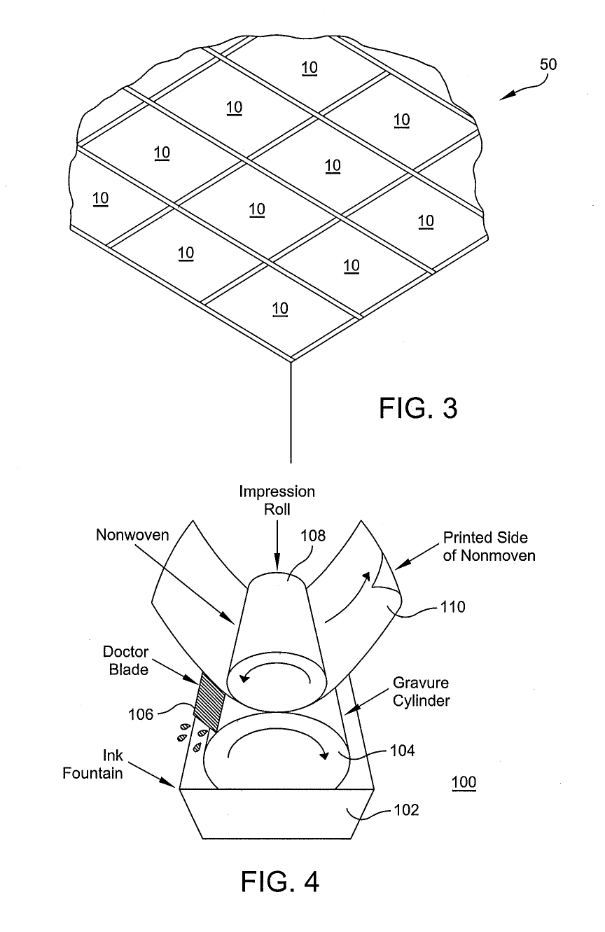

The present invention finds particular application in the creation of individual ceiling tiles or panels that are designed to fit within a standard ceiling tile grid, such as ceiling grid 50 shown in FIG. 3. These tiles come in a standard size of 23¾′ by 23¾″ (nominally 2′ by 2′). Other standard sizes are 2′ by 4′ and 4′ by 4′.

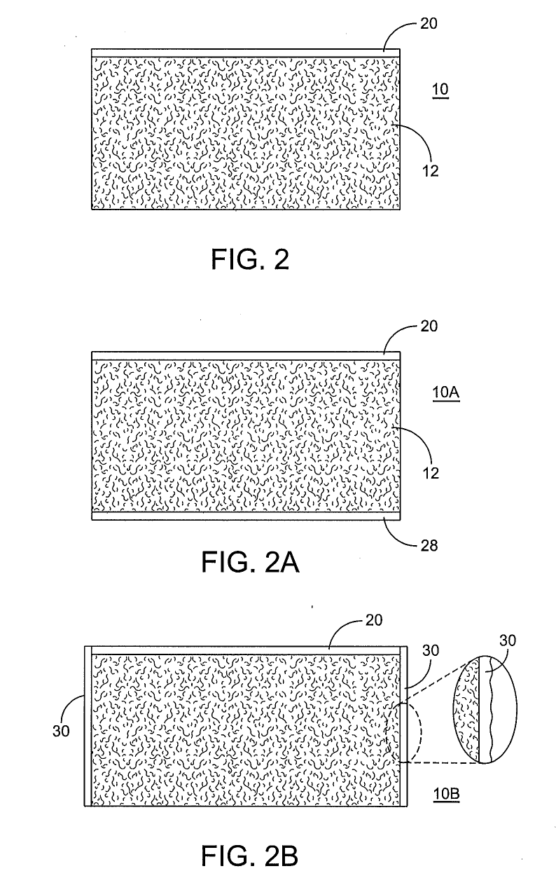

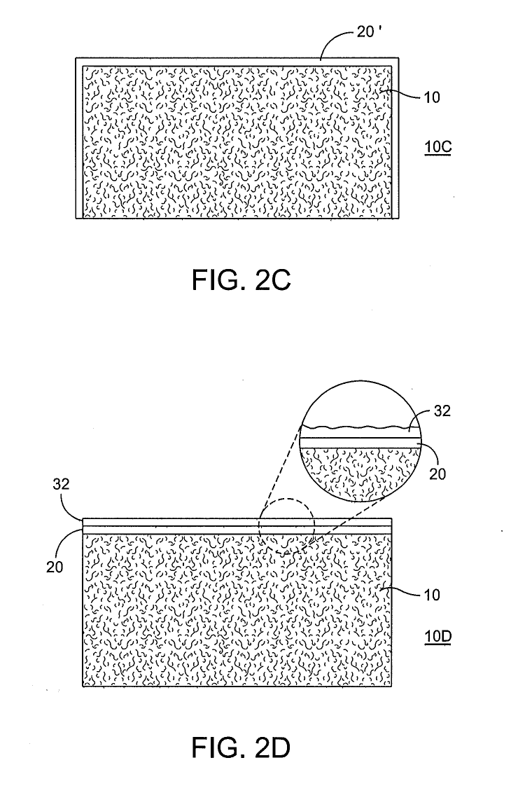

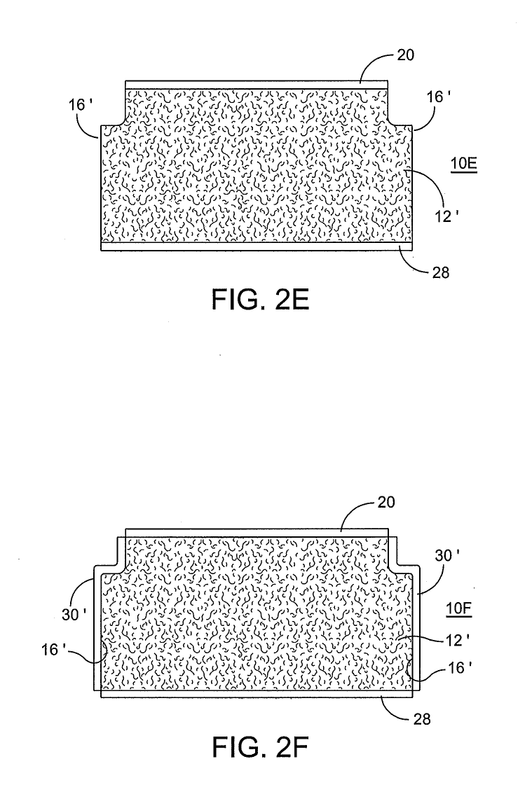

FIG. 2 is a side view of the ceiling panel 10. As can be seen in FIG. 2, the ceiling panel 10 includes base ceiling substrate 12 laminated to non-woven fabric 20. The adhesive layer 26 is not shown.

FIG. 2A is a side view of an alternative embodiment of a ceiling panel 10A. In this embodiment, the bottom surface 18 of the base ceiling substrate 12 is covered with a layer 28, which may be a woven or non-woven layer selected to improve the look and/or feel of the surface 18 of the base ceiling substrate. In embodiments, the layer 28 is a nonwoven made of fiberglass and a combination of other cellulosic and synthetic fibers such as polyester, rayon, polypropylene, etc.

FIG. 2B is a side view of an alternative embodiment of a ceiling panel 10B. In this embodiment, one or more of the side surfaces 16 of the base ceiling substrate 12 are painted with a layer of paint 30. In embodiments, the paint is a standard latex based paint and is used to conceal the edges of the substrate 12.

FIG. 2C is a side view of another alternative embodiment of a ceiling panel 10C. In this embodiment, the non-woven fabric 20′ extends over and is adhered to one or more of the side surfaces 16 of the base ceiling substrate 12. Although not shown in FIG. 2C, the fabric 20 can also be sized to extend around the sides 16 of the base ceiling substrate to cover part or all of the bottom surface 18.

Partial or complete covering or encapsulation of the side and bottom surfaces 16, 18 of the underlying base ceiling substrate 12 using the techniques described above in connection with FIGS. 2A-2C or below in connection with FIGS. 2E and 2F can be used to reduce shedding or dusting from the underlying base ceiling substrate. This type of shedding or dusting is a particular concern in hygienic environments, such as hospitals. For example, covering the side and/or bottom surfaces 16, 18 of a fiberglass panel can help reduce or eliminate the release of fiberglass fibers into the environment during installation or replacement or due to gusts from HVAC systems.

FIG. 2D is a side view of another alternative embodiment of a ceiling panel 10D. In this embodiment, the non-woven fabric layer 20, which has the selected wood image printed thereon, is also coated with an additional coat of paint 30. The paint can be selected to ensure that the non-woven fabric meets a desired targeted flame retardancy, such as a Class A rating on the ASTM E 84 Steiner Tunnel Test. The paint can be selected to also provide a desired visual attribute (e.g., sheen or gloss). This paint layer should be clear and not impact the visibility of the underlying wood-grain image/design that is printed on the non-woven fabric layer 20.

FIG. 2E is a side view of another alternative embodiment of a ceiling panel 10E. This embodiment is similar to the embodiment of FIG. 2A only the top lateral edges of the base ceiling substrate 12′ are routed to form routed side surface 16′. These types of panels are called “reveal edged” panels.

FIG. 2F is a side view of another alternative embodiment of a ceiling panel 10F. In this embodiment, the side surface 16′ of the substrate 12′ is painted with a layer of paint 30′. The layer of paint can cover all of the side surface 30′ or any combination of the three surfaces that form the side surface 16′ (e.g., only the routed step portion).

As will be understood by those familiar with this art, routed edges are provided primarily for visual appearance. It should be understood that a single panel could have two different kinds of paint, e.g., paint layer 32 for providing some physical or visual attribute to the non-woven sheet 20, such as sheen, gloss, better flame retardancy, modified acoustical properties (e.g., sound blocking), metallic finish, etc.) and paint layer 30 or 30′ for encapsulating the side faces 16 or 16′.

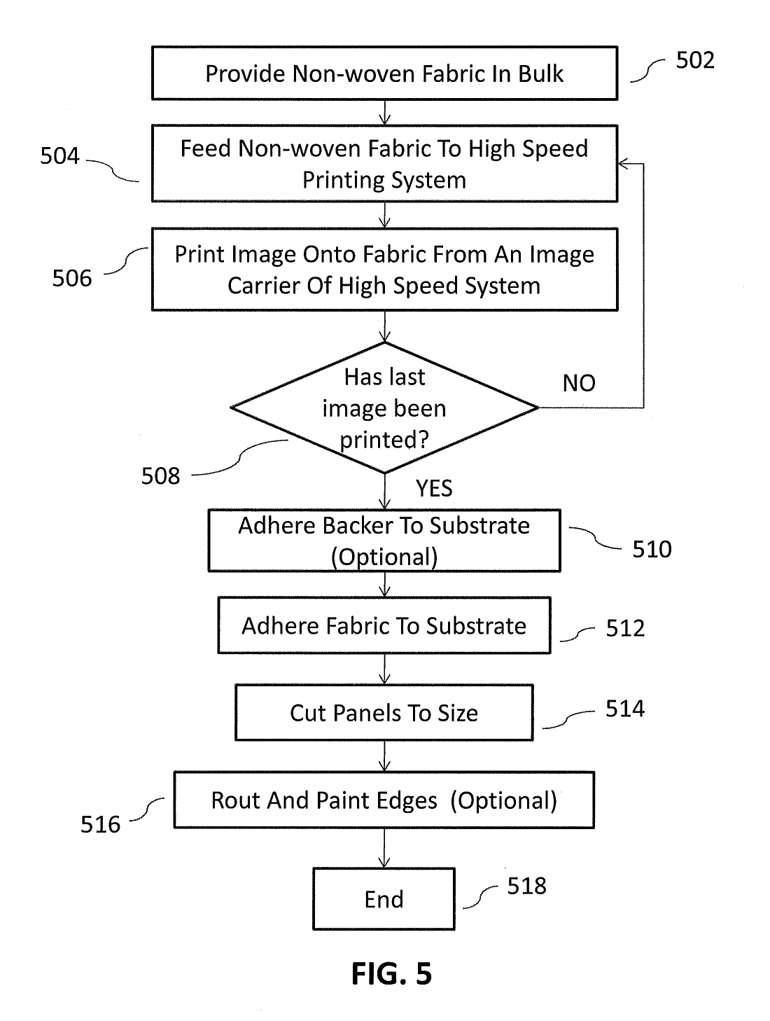

FIG. 5 is a flow diagram illustrating one exemplary process of making the ceiling panel described above. At step 502, the non-woven fabric is provided in bulk form, such as from a roll or other bulk source of the non-woven fabric.

At step 504, the non-woven fabric is fed to a high-speed printing press, such as a high speed automated rotogravure or screen printing press.

At step 506, an image is printed onto a surface of the non-woven fabric from an image carrier (e.g., gravure cylinder in a rotogravure printer or screen/stencil of the screen printing pressed) used in the high-speed printing system.

At step 508, it is determined whether additional layers of ink are required to refine, further define and/or complete the printed image. Forming a wood grain pattern as shown in FIG. 1, for example, will typically require 2 to 5 different printing steps.

If at step 508 additional printing is required, the method returns to step 504 to provide the non-woven fabric to one or more high-speed printing presses for printing additional layers. If at step 508 additional printing is not required, the method proceeds to step 510.

At step 510, optionally, a backer layer is adhered to the back surface of the base ceiling substrate.

At step 512, the non-woven fabric layer is adhered to the base ceiling substrate.

At step 514, the structure (base ceiling substrate with adhered backer and non-woven fabric layer) is cut to size (e.g., 2′×2′, etc.). For example, an image can be printed upon 4′ wide roll of non-woven fabric using a high-speed printing process. Thereafter, the fabric can be laminated in an assembly line process onto a series of 4′ by 8′ sections of base ceiling substrate. A total of eight of the aforementioned nominal 2′ by 2′ tiles, four 2′ by 4′ tiles and two 2′ by 4′ tiles can then be cut from each of the resulting 4′ by 8′ laminated panels.

At step 516, the edges of the base ceiling substrate are optionally routed and/or painted, and the process ends at step 518.

It should be understood that while a wood finish image is one preferred image for printing on the non-woven fabric, the invention can be used to form any of a number of pictures with a pleasing aesthetic appearance. Moreover, the process can be employed to form a number of different laminated panels 10, each with a different individual image that can then be arranged to form a larger, composite picture. A number of laminated panels 10 can be assembled within a ceiling 50 to form a composite picture. Of course, the method can readily be used to form a single decorative panel 10 or to form a number of panels 10 with images that do not necessarily form a composite picture.

With reference to FIG. 4, a rotogravure printing press 100 is shown. Rotogravure is a type of intaglio printing process, in that it involves engraving the image onto an image carrier. In gravure printing, the image is engraved onto a copper cylinder. Rotary gravure presses are the fastest and widest presses in operation, printing everything from narrow labels to 12 feet (4 m)-wide rolls of vinyl flooring. In embodiments, the press 100 is used as the high-speed printing press for printing the image onto the non-woven fabric. It should be understood that the press 100 can be one of a series of presses 100. The number of units varies depending on what colors are required to produce the final image.

Each rotogravure printing press 100 includes an ink fountain 102, an engraved gravure cylinder 104, which includes the image carrier corresponding to the image to be printed, an impression roll 108, a optional doctor blade 106 and a dryer (not shown). The nonwoven sheet 110 is continuously fed to the rotogravure printing press 100 for transfer of the image from the image carrier of the gravure cylinder 104 to the image receiving side of the nonwoven fabric 110. Additional operations may be in-line with a gravure press or presses 100, such as painting and sizing operations.

While the press 100 is in operation, the engraved cylinder 104 is partially immersed in the ink fountain 102, filling the recessed cells of the engraved cylinder 104. As the cylinder 104 rotates, it draws ink out of the fountain 102 with it. The doctor blade 106 is angled toward the cylinder 104 and acts as a squeegee to scrape the cylinder 104 before it makes contact with the nonwoven fabric 110, removing ink from the non-printing (non-recessed) areas. The doctor blade 106 is normally positioned as close as possible to the nip point where the fabric 110 meets the cylinder 108. This is done so ink in the cells has less time to dry out before it meets the fabric 110 via the impression roller(s) 108. Next, the nonwoven fabric 110 gets sandwiched between the impression roller 108 and the gravure cylinder 104. This is where the ink gets transferred from the recessed cells to the printed side of the nonwoven fabric 110. The capillary action of the fabric 110 and the pressure from impression roller(s) 108 draw/force the ink out of the cell cavity and transfer it to the fabric 110. The purpose of the impression roller 108 is to apply force, pressing the fabric 110 onto the gravure cylinder 104, ensuring even and maximum coverage of the ink. Then, the fabric 110 goes through a dryer to completely dry before further processing, such as going through the next color unit and absorbing another coat of ink.

The gravure cylinder 104 can be digitally engraved with the image by a diamond tipped or laser etching machine. On the gravure cylinder 104, the engraved image is composed of small recessed cells (or “dots”) that act as tiny wells. Their depth and size control the amount of ink that gets transferred to the fabric via a process of pressure, osmosis, and electrostatic pull.

In a trial, average speeds of 150-200 ft/min were observed for printing a wood grain image onto a non-woven fabric as described above. With a lane width of 4 feet, that amounts to a production capacity of 600-800 ft²/min. Lane widths of 8 feet could also be used, doubling the production capacity to 1200-1600 ft²/min. Even higher yields can be achieved with wider lanes. To put into perspective, an ink jet printer printing the same image onto a similar fabric would operate at only about 2-4 ft/min.

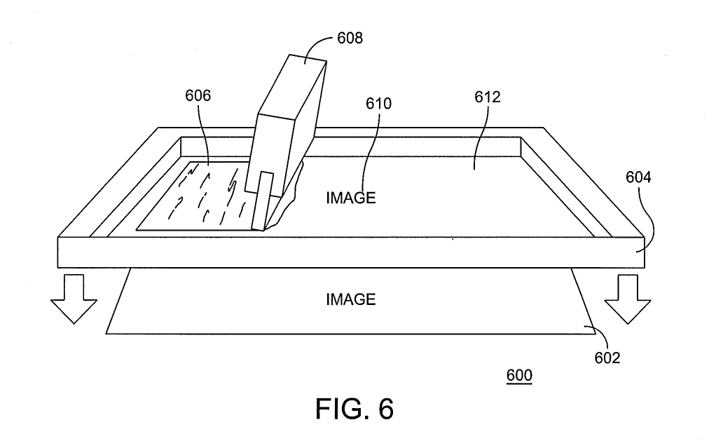

As mentioned above, another alternative high-speed printing technique which can be employed to transfer an image from an image carrier to the fabric is screen printing. FIG. 6 illustrates a screen printing press 600. The screen printing press includes a screen 612 that is made from a piece of porous, finely woven mesh fabric over a frame 604. Most mesh is made of man-made materials such as steel, nylon, and polyester. Areas of the screen are blocked off with a non-permeable material to form a stencil 610, which is a negative of the image to be printed; that is, the open spaces are where the ink will appear. The screen is placed over the nonwoven fabric 602 disclosed above. Ink 606 is spread across the mesh opening with a fill bar (also known as a floodbar) (not shown). The screen is lifted to prevent contact with the underlying non-woven fabric 602 while a slight amount of downward force is applied and the fill bar is pulled across the front of the screen. This effectively fills the mesh openings with ink and moves the ink reservoir to the front of the screen. A squeegee (rubber blade) 608 then moves the mesh down to the fabric layer 602 as it is pushed to the rear of the screen. The ink that is in the mesh opening is pumped or squeezed by capillary action to the fabric 602 in a controlled and prescribed amount, i.e. the wet ink deposit is equal to the thickness of the mesh and or stencil. As the squeegee moves toward the rear of the screen the tension of the mesh pulls the mesh up away from the fabric 602 (called snap-off) leaving the ink upon the fabric 602. In this manner, the IMAGE is transferred to the fabric 602. High speed printing can be achieved by employing automatic presses.

While FIG. 6 illustrates a “flat-bed” type of screen printing, other types of screen-printing, such as “cylinder” or “rotary” may be used.

In exemplary embodiment of the ceiling panel described herein, the ceiling panel has excellent acoustic properties, such as a NRC rating of 0.5 or greater, and more preferably 0.75 or greater, and most preferably 0.8 or greater. NRC is a scalar representation of the amount of sound energy absorbed upon striking a particular surface. An NRC of 0 indicates perfect reflection and an NRC of 1 indicates perfect absorption. NRC is an arithmetic value average of sound absorption coefficients at frequencies of 250, 500, 1000 and 2000 Hz indicating a specimen's ability to absorb sound. NRC values higher than 1.0 are sometimes reported due to the way the number is calculated in a laboratory. A test material's area does not include the sides of the panel (which are exposed to the test chamber) which vary due to its thickness. A certain percentage of the sound is absorbed by the side of the panel due to diffraction effects. While being acoustically transparent and semi-porous, the nonwoven fabric is preferably substantially imperforate. That is, the nonwoven fabric, while semi-porous, need not be perforated, such as by punch holes, wheel abrasions, embossing or the like, in order to obtain the desired acoustical transparency. This feature helps provide an improved image-receiving surface and a smooth look, touch, and feel.

Excellent results were observed in a ceiling panel having an underlying base ceiling substrate that was a fiberglass board having a thickness of 1″ and a density of 4 lb/ft³. A non-woven fabric as described above having a basis weight of 80-100 g/m² and a thickness of 0.010-0.012″ was adhered to the top surface of the base ceiling substrate. The fiber orientation of the non-woven fabric was random. The adhesive was LAW 1913 VETAK adhesive provided in about 2-6 g/m²/ft².

The present disclosure includes that contained in the appended claims, as well as that of the foregoing description. Although the invention has been described in terms of exemplary embodiments, it is not limited thereto. Rather, the appended claims should be construed broadly to include other variants and embodiments of the invention that may be made by those skilled in the art without departing from the scope and range of equivalents of the invention.

What is claimed is:

1. A method of manufacturing an acoustic ceiling panel having an aesthetic covering, comprising the steps of:
providing a non-woven fabric having an outer major printable surface and an inner major surface;
printing an image onto the printable surface of the non-woven fabric using a high-speed printing process, the image being provided from at least one image carrier;
providing a base ceiling substrate having selected acoustical properties, the base ceiling substrate having an outer major surface; and
adhering the inner major surface of the non-woven fabric to the outer major surface of the base ceiling substrate to form a laminated panel, wherein the non-woven fabric is acoustically transparent relative to the base ceiling substrate.

2. The method of claim 1, wherein the non-woven fabric comprises a mix of cellulosic and synthetic fibers.

3. The method of claim 2, wherein the non-woven fabric has a basis weight between about 50-250 g/m² and a thickness between about 0.010-0.200″.

4. The method of claim 1, wherein the base ceiling substrate is selected from the group consisting of mineral board, fiberglass board, gypsum board, and rigid foam board.

5. The method of claim 1, wherein the laminated panel has a NRC value of greater than 0.50.

6. The method of claim 1, wherein the printing step utilizes a high-speed rotogravure printing process with the image carrier comprising a gravure cylinder.

7. The method of claim 1, wherein the printing step utilizes a high-speed screen printing process with the image carrier comprising a screen and stencil.

8. The method of claim 1, wherein the image printed on the non-woven fabric is a simulated wood image.

9. The method of claim 8, wherein the printing step is repeated to apply multiple coats of ink and a simulated wood grain.

10. The method of claim 1, further comprising the steps of after the printing step, cutting the non-woven fabric into a plurality of printed non-woven fabric segments, and wherein the adhering step comprises adhering the plurality of printed non-woven fabric segments onto a corresponding plurality of base ceiling substrates to form a corresponding plurality of ceiling panels.

11. The method of claim 1, further comprising the step of after adhering the non-woven fabric to the base ceiling substrate, cutting the non-woven fabric and base ceiling substrate together into a plurality of ceiling panels.

12. The method of claim 1, wherein the adhering step includes adhering the non-woven fabric to the base ceiling substrate with an adhesive coating including ethyl vinyl acetate, wherein the adhesive coating is provided in a quantity insufficient to appreciably affect the acoustic transparency of the non-woven fabric.

13. The method of claim 1, wherein the non-woven fabric is semi-porous and imperforate, providing a smooth finish for the laminated panel.

14. The method of claim 1, wherein the non-woven fabric comprises a mix of fiberglass, cellulosic and synthetic fibers.

15. The method of claim 1, further comprising the step of applying a coat of paint to the non-woven fabric to improve flame retardancy, modify a finished appearance of the non-woven fabric or modify sound performance characteristics of the non-woven fabric.

16. The method of claim 1, wherein the base ceiling substrate has a density between about 2.5 to 20.0 lbs/ft³ and a thickness between about 0.40 to 3.0″.

17. The method of claim 1, wherein the printing step prints onto the non-woven fabric at a rate of at least 150 ft/min.

18. The method of claim 1, further comprising the step of applying a facing layer to a bottom surface of the base ceiling substrate.

19. The method of claim 18, further comprising the step of painting at least a portion of side surfaces of the base ceiling substrate.

20. The method of claim 1, further comprising the step of routing an edge of base ceiling substrate to form a reveal edges ceiling panel.

21. A method of manufacturing an acoustic ceiling panel having a simulated wood appearance, comprising the steps of:
providing a non-woven fabric having an outer major printable surface and an inner major surface, the non-woven fabric comprising a mix of fiberglass, cellulosic and synthetic fibers, the non-woven fabric being semi-porous, acoustically transparent, imperforate and optically opaque, the non-woven fabric having a weight between about 50-250 g/m² and a thickness between about 0.010-0.200″;
continuously feeding the non-woven fabric to a high-speed rotogravure printing process and printing a simulated wood appearance image onto the printable surface of the non-woven fabric;
providing a base ceiling substrate having selected sound absorption acoustical properties, the base ceiling substrate having an outer major surface;
after the printing step, adhering the inner major surface of the non-woven fabric segment to the outer major surface of the base ceiling substrate to form a laminated panel, wherein the laminated panel has a NRC value of at least 0.75.

22. An acoustic ceiling panel comprising:
a base ceiling substrate having selected acoustical properties, the base ceiling substrate having an outer major surface, the base ceiling substrate being selected from the group consisting of mineral board, fiberglass board, gypsum board, and rigid foam board; and
a non-woven fabric having an outer major printable surface and an inner major surface, the inner major surface being adhered to the outer surface of the base ceiling substrate, the non-woven fabric comprising a mix of fiberglass, cellulosic and synthetic fibers, the non-woven fabric being semi-porous, acoustically transparent, an imperforate, the non-woven fabric having a printed image on the printable surface thereof,
wherein the laminated panel has a NRC value of at least 0.50.

23. The acoustic ceiling panel of claim 22, wherein the printed image is a simulated wood appearance having a simulated wood grain therein.
